(19) United States
(12) Patent Application Publication
(10) Pub. No.: US 2011/0023633 A1
(43) Pub. Date: Feb. 3, 2011

(54) SAMPLE DIVIDER

(75) Inventor: Nils Wihlborg, Helsingborg (SE)

Correspondence Address: HARNESS, DICKEY & PIERCE, P.L.C., P.O. BOX 8910, RESTON, VA, 20195, US

(73) Assignee: Foss Analytical AB, Hoganas (SE)

(21) Appl. No.: 12/736,453

(22) PCT Filed: Apr. 16, 2008
(86) PCT No.: PCT/EP2008/054570

§ 371 Date: Oct. 8, 2010

(51) Int. Cl. G01N 1/20

(52) U.S. Cl. 73/863.41

(57) ABSTRACT

A sample divider for granular material comprises a peripheral wall section and a centrally located sample spreading member which here is in the form of an upwardly facing cone. A first plurality of holes is distributed evenly around the peripheral wall and together serves as an outlet of a first discharge stage. A second plurality of holes is located in and evenly distributed around an inner wall section and together serves as an outlet of a second discharge stage. Each chute from a plurality of such chutes is associated with its own one of the plurality of holes and is angled to direct incident sample towards the associated hole.

The present invention relates to a sample divider for a flowable particulate material.

In the analysis of particulate material, particularly particulate organic material such as grains or foodstuffs, it is often necessary to obtain a representative sample on which to make the analysis. Typically, representative samples are taken from bulk material stores or from a flowing stream of the bulk material and usually the resultant sample quantity is simply too large to be analysed in an analysis instrument. It is for this reason that a sample divider is used to generate one or more sub-sample quantities that are each representative of the initial particulate sample but which may more easily be analysed in the analysis instrument.

One construction of a sample divider is known which comprises a sample delivery pipe, a slidable sleeve, a divider and collecting vessels for sub-samples each arranged one below the other. The divider is constructed with a first sample spreading member, here in the form of a divider cone, which has distributed over its base surface sample distribution holes to which a plurality of first sub-sample pipes is connected, below which are arranged a collecting funnel, a second sample spreading member, again formed as a divider cone, and below that a plurality of second sub-sample pipes which are connected to the collecting vessels. In this way an initial sample quantity can be divided up into a comparatively large number of representative sub-sample quantities. The sleeve is vertically movable between the delivery pipe and the first divider cone, against which it seals, and a drive means is provided to pulse the sleeve into and out of contact with this cone.

One problem that may arise with such a known construction is that mechanical vibrations may occur due to the operation of the drive means which may then cause a redistribution of the particles of the initial sample quantity waiting to pass through the divider. Basically the smaller particles tend to be vibrated downwards such that the sub-sample quantities are no longer representative of the initial sample.

It is an aim of the present invention to provide a sample divider for particulate material having no moving parts.

This is achieved by the sample divider described in and characterised by the present claim 1. By having collection chutes that are angled, preferably in alternating fashion, to direct sample towards a first or a second outlet then two sub-samples are created, each of which is representative of the initial sample.

Most usefully a stacked arrangement of a plurality of same sample dividers may be provided, for example in a divider cassette, and configured such that a one of the sample dividers may receive onto its sample spreading member a one of the sub-samples from an immediately preceding sample divider. In this manner smaller quantity sub-samples may be provided, each being representative of the initial sample.

Exemplary embodiments of the invention will now be described with reference to the drawings of the accompanying figures, of which:

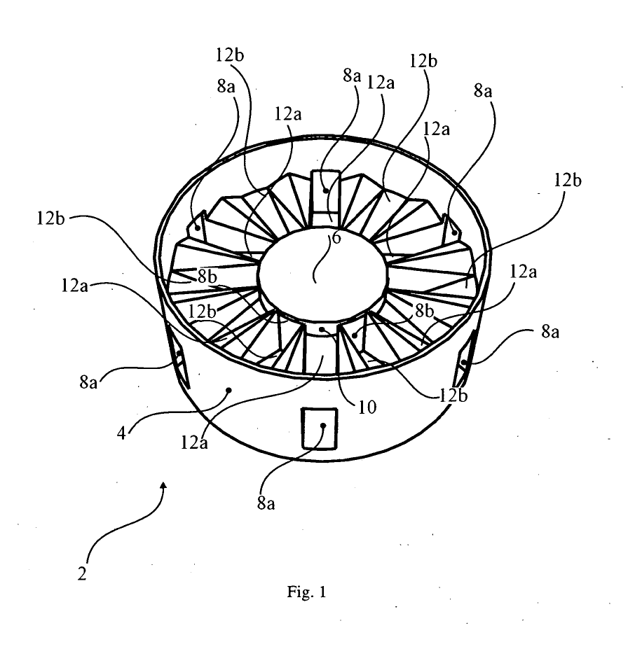

FIG. 1 shows a sample divider according to a first embodiment of the present invention; and

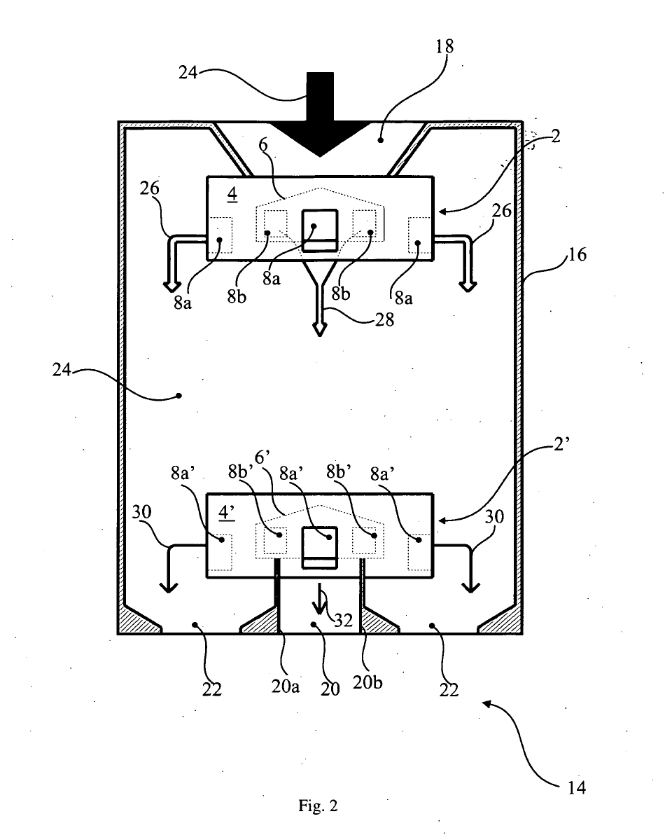

FIG. 2 shows a sample divider cassette, comprising a stacked arrangement of a plurality of sample dividers according to the embodiment of FIG. 1.

Considering now FIG. 1 in which is shown a generally cylindrical sample divider 2 according to the present invention. The divider 2 comprises a peripheral wall section 4 and a centrally located sample spreading member which here is in the form of an upwardly facing cone 6. Holes of a plurality of holes 8a are distributed evenly around the peripheral wall 4 and together serve as an outlet for a first discharge stage. A same plurality of holes 8b are located in and evenly distributed around an inner peripheral wall section 10 and together serve as an outlet for a second discharge stage. The holes 8a, 8b of the first and the second discharge stages respectively are arranged to be circumferentially staggered from one another in an alternating fashion. Whilst these two sets of holes 8a and 8b are here illustrated as being located in associated peripheral wall sections 4, 10 it will be appreciated that similar functionality may be provided by a divider having the two sets of holes 8a, 8b radially staggered from one another, such as for example by locating one or both of the sets of holes in a floor section of the divider.

A plurality of chutes 12a, 12b are provided each operably connected to a different one of the plurality of the holes 8a, 8b and each angled to direct incident sample towards its associated hole 8a or 8b. The chutes 12a, 12b and associated holes 8a, 8b together form respectively the first and the second discharge stages.

Preferably, as illustrated in FIG. 1, the chutes 12a, 12b are arranged to be angled in an alternating fashion towards their respective holes 8a of the first discharge stage and their holes 8b of the second discharge stage. In the present embodiment the chutes 12a, 12b designed to present to spread sample equal total sample collection regions for the first and the second discharge stages and so provide equally sized sub-samples.

With this arrangement a flowing, particulate initial sample (not shown) which is incident substantially vertically on the cone 6 becomes evenly distributed around the periphery of the divider, as delimited by the peripheral wall 4. Since chutes 12a, which act to direct particles of the sample towards the holes 8a of the first discharge stage, alternate with chutes 12b, which act to direct particles of the sample towards the holes 8b of the second discharge stage, then the initial sample is divided into two sub-samples each of which, in the present embodiment, are substantially equal in size, and each of which, generally, is representative of the other and of the initial sample.

It will be appreciated that a vertically stacked arrangement of a plurality of such sample dividers 2 may be provided and cooperatively disposed such that the sub-sample generated from either the first (here comprising the plurality of holes 8a) discharge stage or the second (here comprising the plurality of holes 8b) discharge stage of an immediately preceding divider in the stack is incident on a spreading member 6 of next divider 2 in the stack. In this manner smaller and smaller representative subs-samples may be easily generated.

One such stacked arrangement is illustrated in the embodiment of FIG. 2. Here, by way of example only, a divider cassette 14 is shown which, for ease of description, comprises two sample dividers 2, 2′ according to the embodiment of FIG. 1. For the sake of clarity these dividers 2, 2′ are shown physically separated but it is intended that a cassette 14 may be provided in which these dividers 2, 2′ abut one another.

The dividers 2, 2′ are located within a housing 16. The housing 16 is provided with an inlet 18 a central outlet 20 and peripheral outlets 22 and is dimensioned to provide a sample receiving volume 24 around the peripheral wall sections 4, 4′ of the associated dividers 2, 2′.

The dividers 2, 2′ are collocated within the housing 16 such that the associated sample spreading members 6, 6′ are arranged vertically below one another between the inlet 18 and the central outlet 20. The central outlet 20 may, entirely optionally, be provided with side walls 20a, 20b that extend into the housing 16 and which then acts to help locate a last one of the plurality of sample dividers (here 2′) centrally within the housing 16 and preferably abutting a bottom wall of the housing 16.

In use a primary, flowable, particulate sample 24, such a cereal grains, is poured into the cassette 14 through the inlet 18 to impinge upon the spreading member 6 of the first sample divider 2. The inlet 18 may have a shape, such as the funnel shape illustrated in the present embodiment, to help direct the cereal grains on to the spreader 6. The incident grains are then distributed evenly towards the peripheral wall 4 and the collection chutes that are associated with the first plurality of holes 8a and the second plurality of holes 8b from where they exit the first divider 2.

In this manner the initial sample 24 is divided into two equal and representative sub-samples 26 and 28 which have respectively exited the first discharge stage (8a, 12a) and the second discharge stage (8b, 12b).

Those grains of the sub-sample 28 that exited the discharge stage (8b, 12b), arranged towards the centre of the first sample divider 2, form a secondary, flowable, particulate sample as an input to the second sample divider 2′. As described above, this second sample divider 2′ is disposed vertically below the first 2 and so the secondary input flow 28 impinges upon the sample spreading member 6′ of the second divider 2′.

In a manner as described in respect of the primary sample 24 input to the first divider 2, the secondary sample is divided by the second divider 2′ into two equal and representative sub-samples 30, 32.

In the present embodiment the sub-sample 30, which exits the first discharge stage (8a′,12a′) in the peripheral wall 4′ of the second divider 2′ combines with the corresponding sub-sample 26 which exited the first discharge stage (8a, 12a) in the peripheral wall 4 of the first divider 2 to exit the housing 16 through peripheral outlets 22. The so produced sub-sample represents three quarters of the amount of the primary sample 24 and may be collected for further analysis, dumped or returned to a bulk material from which the primary sample 24 was taken.

The sub-sample 32 which exits the housing 16 through the central outlet 20 represents one quarter of the amount of the initial, primary sample 24 and, most typically, is collected for further analysis but could alternatively be dumped or returned to the bulk material.

It will be appreciated that the sub-sample 32 could form a tertiary sample for input to a third sample divider to generate a smaller sub-sample, and so on until a desired fraction of the primary sample is generated which remains representative of this primary sample 24.

1. A sample divider comprising an outer peripheral wall and a sample spreading member configured to spread a substantially vertically incident particulate sample flow outwards towards the outer peripheral wall wherein there is provided a first discharge stage comprising a first outlet and associated therewith a plurality of collection chutes each angled to direct sample spread by the spreading member towards the first outlet; and a second discharge stage comprising a second outlet and associated therewith a plurality of collection chutes angled to direct sample spread by the spreading member towards the second outlet.

2. A sample divider as claimed in claim 1 wherein the first outlet comprises a plurality of holes each having associated therewith a one of a corresponding plurality of the collection chutes; and in that the second outlet comprises a plurality of holes each having associated therewith a one of a corresponding plurality of the collection chutes.

3. A sample divider as claimed in claim 1 wherein the first outlet comprises a plurality of holes disposed in the outer peripheral wall.

4. A sample divider as claimed in claim 1 wherein there is provided an inner peripheral wall proximal the sample spreading member and in that the second outlet comprises a plurality of holes disposed in the inner peripheral wall.

5. A sample divider as claimed in claim 1 wherein the plurality of chutes are individually angled in an alternating manner so as to direct sample alternately towards the first and the second outlets.

6. A sample divider as claimed in claim 5 wherein the chutes are numbered and dimensioned to present substantially similarly total collection regions for each of the first and the second discharge stages.

7. A sample divider as claimed in claim 1 wherein it is configured with a cylindrical outer peripheral wall and in that the sample spreading member comprises a centrally located, upwardly facing cone.

8. A sample divider cassette wherein the cassette comprises a plurality of sample dividers as claimed in claim 1 disposed in a vertically stacked arrangement such that a one of the plurality of sample dividers may receive onto its sample spreading member a one of the sub-samples from an immediately preceding sample divider of the plurality.
